(19) United States
(12) Patent Application Publication
(10) Pub. No.: US 2017/0161861 A1
(43) Pub. Date: Jun. 8, 2017

(54) SYSTEM FOR PROVIDING A TRANSPORTATION CALL SERVICE AND FARE PAYMENT SERVICE AND METHOD USING THE SAME

(71) Applicant: NHN Entertainment Corporation, Seongnam-si (KR)

(72) Inventors: Seung Jin HONG, Seongnam-si (KR); Bomyoung OH, Seongnam-si (KR)

(21) Appl. No.: 15/371,423

(22) Filed: Dec. 7, 2016

(30) Foreign Application Priority Data
Dec. 7, 2015 (KR) 10-2015-0172905

(51) Int. Cl. G06Q 50/30; G07B 15/00

(52) U.S. Cl. CPC G06Q 50/30; G07B 15/00

(57) ABSTRACT

A system and method is disclosed for providing a transportation call service and fare payment service in response to a user's call request, including a first terminal configured to generate a transportation call request and a first settlement request for a first settlement of payment of a transportation fare; a transportation call server configured, in response to receiving the transportation call request from the first terminal, to generate a vehicle assignment message indicating the a vehicle has been assigned and to transmit the vehicle assignment message to the first terminal; and a payment agent server configured to process the payment of the transportation fare using an actual fare information and the first settlement request, wherein the actual fare information is generated according to a service operation of the assigned vehicle.

### CROSS REFERENCE TO RELATED APPLICATION

This application claims priority from and the benefit of Korean Patent Application No. 10-2015-0172905, filed on Dec. 7, 2015, which is hereby incorporated by reference for all purposes as if fully set forth herein.

### BACKGROUND

Field

Exemplary embodiments relate to a transportation call server and a method for providing transportation call service. More specifically, exemplary embodiments relate to a transportation call server and a method for providing transportation call service and for processing payment, using data communication with a plurality of user mobile devices and vehicle devices.

Discussion of the Background

In modern society, various transportation means are used. In providing transportation services, efficiently matching supply and demand is important.

For example, a taxi call service is one of the conventional transportation services that call taxies on behalf of passengers to request transportation service. For taxi call services, when a passenger makes phone call to a service provider, an operator of the service provider finds available taxies near the passenger and assigns one of them to the passenger. Then, the assigned taxi will pick up the passenger.

However, in the conventional transportation call service such as a taxi call service, the passenger has little discretion over the operator's assignment of transportation service because the passenger is not involved during the assignment process. Also, the conventional transportation call service may cause considerable delay in service due to the time needed for operators to receive phone calls from passengers, find available transportation, and contact the available transportation on behalf of the passengers. In addition, the service provider or drivers may incur considerable expenses for hiring operators.

Also, according to the conventional taxi call service, payment of fare is made when the passenger is getting off the vehicle at the destination.

The above information disclosed in this Background section is only for enhancement of understanding of the background of the inventive concept, and, therefore, it may contain information that does not form the prior art that is already known in this country to a person of ordinary skill in the art.

### SUMMARY

Exemplary embodiments provide transportation call service system including a first terminal, a transportation call server, and a payment agent server.

Additional aspects will be set forth in the detailed description which follows, and, in part, will be apparent from the disclosure, or may be learned by practice of the inventive concept.

Exemplary embodiments provide a system for providing a transportation call service and payment service in response to a user's call request, including a first terminal configured to generate a transportation call request and a first settlement request for a first settlement of a payment of a transportation fare; a transportation call server configured, in response to receiving the transportation call request from the first terminal, to generate a vehicle assignment message indicating the a vehicle has been assigned and to transmit the vehicle assignment message to the first terminal; and a payment agent server configured to process the payment of the transportation fare using an actual fare information and the first settlement request, wherein the actual fare information is generated according to a service operation of the assigned vehicle.

The system may further include a second terminal configured to receive a call request information from the transportation call server, to generate an acceptance message indicating that the transportation call request is accepted, and to transmit the acceptance message to the transportation call server. The call request information is generated by the transportation call server based on the transportation call request.

The payment agent server may be further configured to generate a second settlement request including the actual fare information and transmits the second settlement request to a card issuer server for settlement of the payment of the transportation fare.

The payment agent server may be further configured to store an automatic payment information for allowing the payment of transportation fare to be automatically processed. In this embodiment, the first settlement request further includes a user identification information which the payment agent server compares with the stored automatic payment information to perform the automatic payment process in response to receiving the first settlement request, and the second settlement request includes the actual fare information.

The first settlement request may include a request for provisional approval of the pre-estimated fare, and the second settlement request may include a request for a formal approval of the transportation fare, wherein the transportation fare is the actual fare if the actual fare is equal to or smaller than the pre-estimated fare and the pre-estimated fare if the actual fare is larger than the pre-estimated fare.

The first settlement request may include a request for prepayment of the pre-estimated fare, and the second settlement request include a request for validating the prepayment when the actual fare is equal to or larger than the pre-estimated fare and a request for canceling a exceeded amount of the pre-estimated fare when the actual fare is smaller than the pre-estimated fare.

The payment agent server may be further configured to generate an additional fare notification indicating that the actual fare is determined to be larger than the pre-estimated fare and payment for a difference between the actual fare and the pre-estimated fare is need to be processed, and to transmit the additional fare notification to the second terminal when the actual fare is determined to be larger than the pre-estimated fare.

Exemplary embodiments also provide a method for providing a transportation call service and payment service in response to a user's call request, the method performed by a first terminal. The method includes transmitting a transportation call request to the transportation call server, receiving a vehicle assignment message from the transportation call server, wherein the vehicle assignment message indicating a vehicle has been assigned is generated by and transmitted from the transportation call server in response to the transportation call request, and transmitting a first settlement request to the payment agent server so that the payment agent server processes a payment of a transportation fare using an actual fare information and the first settlement request, wherein the actual fare information is generated according to a service operation of the assigned vehicle.

Exemplary embodiments also provide a method for providing a transportation call service and payment service in response to a user's call request, the method performed by a payment agent server. The method includes receiving a first settlement request for a first payment process from the first terminal, receiving a pre-estimated fare information generated according to a transportation of the assigned vehicle, and processing payment of transportation fare using an actual fare and the first settlement request.

The foregoing general description and the following detailed description are exemplary and explanatory and are intended to provide further explanation of the claimed subject matter.

### BRIEF DESCRIPTION OF THE DRAWINGS

The accompanying drawings, which are included to provide a further understanding of the inventive concept, and are incorporated in and constitute a part of this specification, illustrate exemplary embodiments of the inventive concept, and, together with the description, serve to explain principles of the inventive concept.

FIG. 1 is a schematic diagram illustrating a transportation call service system according to an exemplary embodiment.

FIG. 2 is a flowchart illustrating an exemplary process for payment of transportation fare using the transportation call service system of FIG. 1.

FIG. 3 is a diagram illustrating an exemplary process of the transportation call service using the service system of FIG. 1.

FIG. 4 is a diagram illustrating an exemplary first stage of payment process after processes of FIG. 3.

FIG. 5 is a block diagram illustrating an exemplary second stage of payment process after the processes of FIG. 4.

FIG. 6 is a flowchart illustrating an exemplary embodiment of a transportation call service system and fare payment service.

FIG. 7 is a block diagram illustrating an example of a process of first settlement according to the payment scenario of FIG. 6.

FIG. 8 is a block diagram illustrating an example of a process of call and acceptance of the transportation call service in FIG. 7.

FIG. 9 is a flowchart illustrating an example of a process of first settlement and second settlement according to the payment scenario of FIG. 2 and/or FIG. 6.

FIG. 10 is a flowchart illustrating an exemplary process of first settlement and second settlement in the transportation fare payment scenario of FIG. 2 and/or FIG. 6.

FIG. 11 is a flowchart illustrating an exemplary process of first settlement and second settlement in the transportation fare payment scenario of FIG. 2 and/or FIG. 6.

### DETAILED DESCRIPTION OF THE ILLUSTRATED EMBODIMENTS

In the following description, for the purposes of explanation, numerous specific details are set forth in order to provide a thorough understanding of various exemplary embodiments. It is apparent, however, that various exemplary embodiments may be practiced without these specific details or with one or more equivalent arrangements. In other instances, well-known structures and apparatus are shown in block diagram form in order to avoid unnecessarily obscuring various exemplary embodiments.

In the accompanying figures, the size and relative sizes of elements may be exaggerated for clarity and descriptive purposes. Also, like reference numerals denote like elements.

When an element is referred to as being “on,” “connected to,” or “coupled to” another element, it may be directly on, connected to, or coupled to the other element or intervening elements may be present. When, however, an element is referred to as being “directly on,” “directly connected to,” or “directly coupled to” another element or layer, there are no intervening elements present. For the purposes of this disclosure, “at least one of X, Y, and Z” and “at least one selected from the group consisting of X, Y, and Z” may be construed as X only, Y only, Z only, or any combination of two or more of X, Y, and Z, such as, for instance, XYZ, XYY, YZ, and ZZ. As used herein, the term “and/or” includes any and all combinations of one or more of the associated listed items.

Although the terms “first,” “second,” etc. may be used herein to describe various elements, components, regions, and/or sections, these elements, components, regions, and/or sections should not be limited by these terms. These terms are used to distinguish one element, component, region, and/or section from another element, component, region, and/or section. Thus, a first element, component, region, and/or section discussed below could be termed a second element, component, region, and/or section without departing from the teachings of the present disclosure.

Spatially relative terms, such as “beneath,” “below,” “lower,” “above,” “upper,” and the like, may be used herein for descriptive purposes, and, thereby, to describe one element or feature's relationship to another element(s) or feature(s) as illustrated in the drawings. Spatially relative terms are intended to encompass different orientations of an apparatus in use, operation, and/or manufacture in addition to the orientation depicted in the drawings. For example, if the apparatus in the drawings is turned over, elements described as “below” or “beneath” other elements or features would then be oriented “above” the other elements or features. Thus, the exemplary term “below” can encompass both an orientation of above and below. Furthermore, the apparatus may be otherwise oriented (e.g., rotated 90 degrees or at other orientations), and, as such, the spatially relative descriptors used herein interpreted accordingly.

The terminology used herein is for the purpose of describing particular embodiments and is not intended to be limiting. As used herein, the singular forms, “a,” “an,” and “the” are intended to include the plural forms as well, unless the context clearly indicates otherwise. Moreover, the terms “comprises,” “comprising,” “includes,” and/or “including,” when used in this specification, specify the presence of stated features, integers, steps, operations, elements, components, and/or groups thereof, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this disclosure is a part. Terms, such as those defined in commonly used dictionaries, should be interpreted as having a meaning that is consistent with their meaning in the context of the relevant art and will not be interpreted in an idealized or overly formal sense, unless expressly so defined herein.

Exemplary embodiments may be described with reference to acts and symbolic representations of operations (e.g., in the form of flow charts, flow diagrams, data flow diagrams, structure diagrams, block diagrams, etc.) that may be implemented in conjunction with units and/or devices discussed in more detail below. Although discussed in a particularly manner, a function or operation specified in a specific block may be performed differently from the flow specified in a flowchart, flow diagram, etc. For example, functions or operations illustrated as being performed serially in two consecutive blocks may actually be performed simultaneously, or in some cases be performed in reverse order.

Hereinafter, exemplary embodiments will be described with reference to the accompanying drawings.

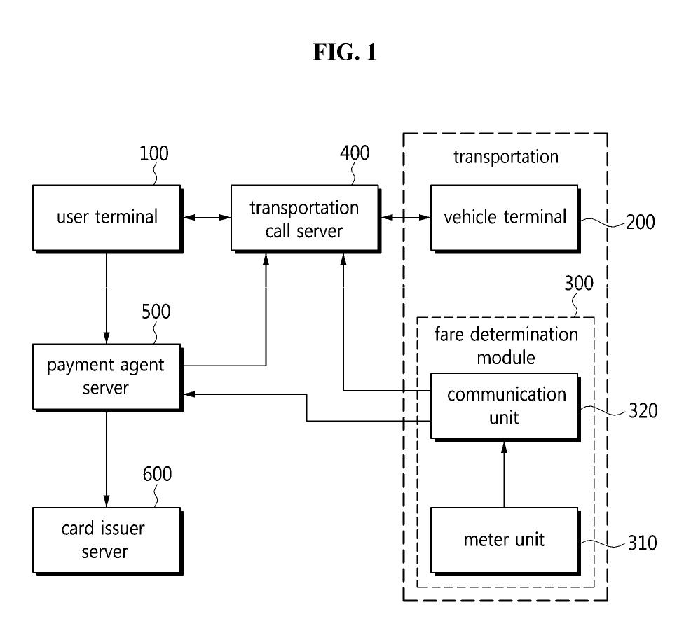

FIG. 1 is a schematic diagram illustrating a transportation call service system according to an exemplary embodiment.

Referring to FIG. 1, an exemplary transportation call service includes at least one user terminal 100, at least one vehicle terminal 200, at least one fare determination module 300, a transportation call server 400, and a payment agent server 500. The user terminal 100 and the vehicle terminal 200 may include, for example, smartphone, tablet, or notebook PC capable of wireless communication. The transportation call server 400 may be connected to a data network to exchange signals with the user terminal 100 and vehicle terminal 200 via respective wireless transceivers.

The user terminal 100 may belong to a user who has subscribed to a transportation call service. The user may be a passenger of the transportation call service or non-passenger user. For example, if a user A wants to call a taxi, a user B, an acquaintance of A, may call a taxi using the present service system on behalf of user A. In this case, the user terminal 100 may belong to user B who is a non-passenger user. As such, in the system and method described below, the user terminal 100 is not limited to a passenger's terminal and may belong to a person who accesses the transportation call service system to call for a transportation means on behalf of the passenger.

The vehicle terminal 200 may be a computing device which belongs to a driver driving a transportation vehicle or is equipped to a vehicle. For example, the vehicle terminal 200 may be at least one of a smartphone, PDA, tablet, and notebook PC a driver possesses or at least one of an infotainment system, tablet, or navigating system equipped to a transportation vehicle, but the exemplary embodiments are not limited thereto. The transportation call server 400 may provide the user terminal 100 and the vehicle terminal 200 with a transportation call service. Hereinafter, an exemplary embodiment of how the transportation call server 400 provides the user terminal 100 and the vehicle terminal 200 with a transportation call service will be described.

The fare determination module 300 may be a device equipped to a transportation vehicle to process payment of transportation fare via wireless communication network. For example, each of the fare determination modules 300 may include a meter unit 310 calculating transportation fare based on distance and time of transportation, and a communication unit 320 receiving the transportation fare from the meter unit 310 to process the payment of the transportation fare. The communication unit 320 may be a device capable of wireless communication to transmit the transportation fare to the transportation call server 400 or the payment agent server 500. In addition, the meter unit 310 and the communication unit 320 may be integrated into a single device, such as meter unit being capable of processing the transportation fare and transmitting processed payment data via wireless communication network, but exemplary embodiments are not limited thereto.

The transportation call server 400 may be a computer system capable of performing the transportation call service automatically and exchanging data and signals with the user terminals 100, vehicle terminals 200, fare determination modules 300, and payment agent server 500 via wireless communication network. In addition, the transportation call server 400 may include, for example, a map DB (database), a vehicle DB, a wireless communication unit, vehicle assignment information storage unit, and a control unit (not illustrated).

The map DB may store geographic information including maps of service territories. The control unit may control operation of the map DB to load at least a part of the geographic information and update the map DB if update is required. The vehicle DB may store vehicle information related to transportation vehicles subscribed to the transportation call service. The control unit may control operation of the vehicle DB to load at least a part of the vehicle information and update the vehicle DB if update is required. The wireless communication unit may access the data network to exchange data with the user terminal 100 and vehicle terminal 200. The control unit controls operation of the wireless communication unit to transmit various signals and data to the user terminal 100 and the vehicle terminal 200, and to receive various signals and data from the user terminal 100 and the vehicle terminal 200. The vehicle assignment information storage unit may store vehicle assignment information. The vehicle assignment information may include real time status of vehicle assignment to passengers. The control unit may load at least a part of the vehicle assignment information from the vehicle assignment information storage and update the vehicle assignment information in real time when a new assignment between a passenger and a vehicle occurs and/or the status changes. In exemplary embodiments, the map DB, the vehicle DB, the wireless communication unit, the vehicle assignment information storage, and the control unit, and/or one or more components thereof, may be implemented via one or more general purpose and/or special purpose components, such as volatile or non-volatile memory devices and one or more discrete circuits, digital signal processing chips, integrated circuits, application specific integrated circuits, microprocessors, processors, programmable arrays, field programmable arrays, instruction set processors, and/or the like.

According to exemplary embodiments, the features, operations, processes, etc., described herein may be implemented via software, hardware (e.g., general processor, digital signal processing (DSP) chip, an application specific integrated circuit (ASIC), field programmable gate arrays (FPGAs), etc.), firmware, or a combination thereof. In this manner, the map DB, the vehicle DB, the wireless communication unit 330, the vehicle assignment information storage and the control unit, and/or one or more components thereof may include or otherwise be associated with one or more memories (not shown) including code (e.g., instructions) configured to cause the map DB, the vehicle DB, the wireless communication unit 330, the vehicle assignment information storage, and the control unit, and/or one or more components thereof to perform one or more of the features, functions, processes, etc., described herein.

The memories and DBs may be any medium that participates in providing code to the one or more software, hardware, and/or firmware components for execution. Such memories may be implemented in any suitable form, including, but not limited to, non-volatile media, volatile media, and transmission media. Non-volatile media may include, for example, optical or magnetic disks. Volatile media may include, for example, dynamic memory. Transmission media may include, for example, coaxial cables, copper wire, and fiber optics. Transmission media may also take the form of, for example, acoustic, optical, or electromagnetic waves. Common forms of computer-readable media may include, for example, a floppy disk, a flexible disk, hard disk, magnetic tape, any other magnetic medium, a compact disk-read only memory (CD-ROM), a rewriteable compact disk (CDRW), a digital video disk (DVD), a rewriteable DVD (DVD-RW), any other optical medium, punch cards, paper tape, optical mark sheets, any other physical medium with patterns of holes or other optically recognizable indicia, a random-access memory (RAM), a programmable read only memory (PROM), and erasable programmable read only memory (EPROM), a FLASH-EPROM, any other memory chip or cartridge, a carrier wave, or any other medium from which information may be read by, for example, a controller/processor.

The payment agent server 500 may be a computer system intervening between the user terminal 100 and card issuer server 600 to process payment of the transportation fare. For example, the payment agent server 500 may be a server operated by a payment agent entity, e.g., PAYCO™ or PayPal™.

The card issuer server 600 may be a computer system operated by a card issuer, e.g., VISA, Master, American Express and the like. The card issuer server 600 may approve, in response to a request from the payment agent server 500, the payment of the transportation fare according at least one of the payment means including, for example, credit card, debit card, phone payment, wire transfer, prepaid payment means, coupons, and mileages.

According to an exemplary embodiment, the user A may download an application for the transportation call service (hereinafter ‘transportation call service app’) and install it on his or her user terminal 100. A process of joining or subscribing to the transportation call service, i.e., registration of membership, and logging in the transportation call service may be further required. Then, the user A may register at least one payment means for paying transportation fares. The payment means may be, for example, a credit card, a debit card, phone payment, a bank account for wire transfer, coupons, prepaid card, or mileages. User A, who may be a passenger, may register one or more of the payment means and the payment agent server 500 may store the one or more registered payment means. The payment agent server 500 may process the payment of the transportation fares, according to the user's selection, by one or more of the registered payment means.

Hereinafter, a method of transportation call service using the above transportation call service system will be described in more detail.

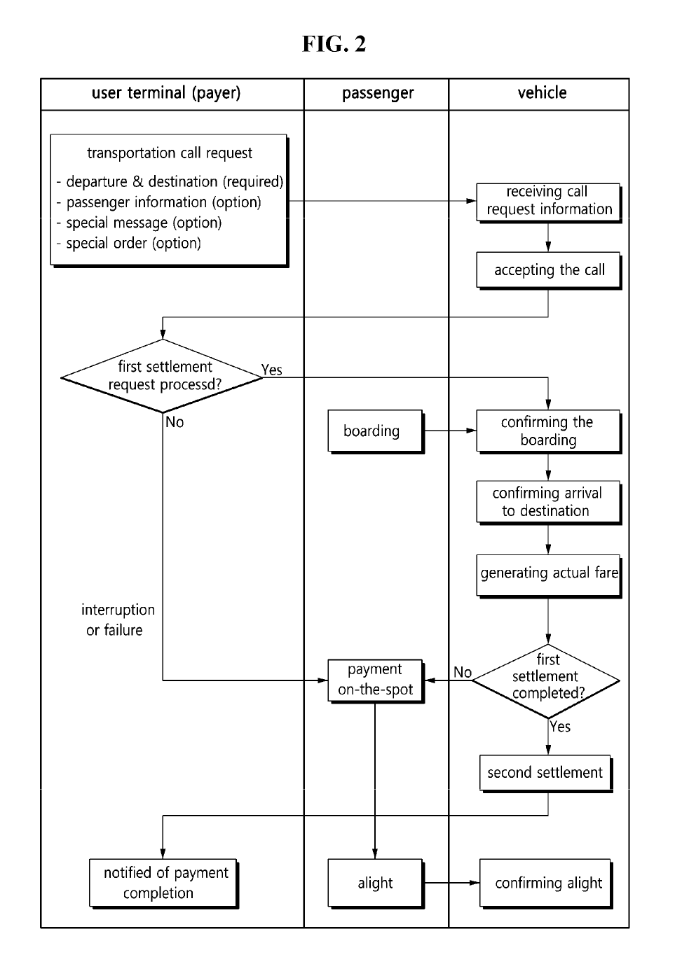

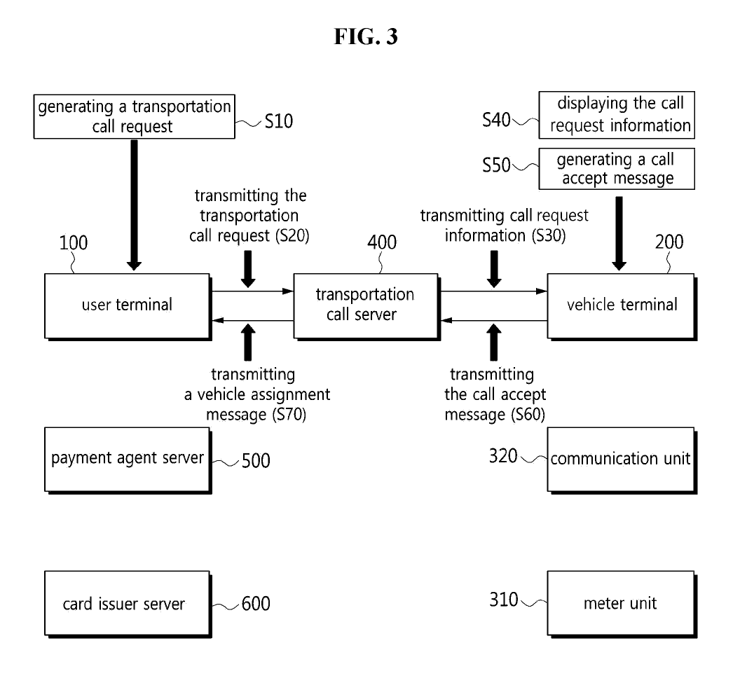

FIG. 2 is a flowchart illustrating an exemplary process for payment of transportation fare using the transportation call service system of FIG. 1, and FIG. 3 is a diagram illustrating an exemplary process of the transportation call service using the service system of FIG. 1.

Referring to FIG. 2 and FIG. 3, a user terminal 100 of a user (for example, user A) may generate a transportation call request in response to a user input (S10). For example, the user may execute a transportation call service app installed on the user terminal 100 to input a transportation call request for a transportation vehicle. According to an exemplary embodiment, the transportation call request may include information about departure and destination. In addition, the transportation call request may further include passenger information, a message to be delivered to a driver of the vehicle, a special request, etc. The user terminal 100 then transmits the transportation call request to the transportation call service server 400 (S20).

The transportation call service server 400 may generate a call request information based on the transportation call request and may transmit the call request information to a plurality of vehicle terminals 200 (S30). The call request information may be identical to the transportation call request, or may include a part of the transportation call request, or may include other information in addition to the transportation call request, but exemplary embodiments are not limited thereto.

The vehicle terminal 200 may display the call request information (S40). Herein, “display” may include not only visually displaying the information but also notifying a service operator or vehicle driver of the passenger's call request information by sound, vibration, etc.

Then, the vehicle terminal 200 may generate a call accept message and may transmit the call accept message to the transportation call server 400 (S60). For example, a driver of a vehicle acting as an operator may input whether he or she accepts the user's transportation call request through the vehicle terminal 200 after he or she is notified of the call request information. The vehicle driver may input the call accept message via a touch screen of the vehicle terminal 200. The vehicle terminal 200 may have other user input interfaces to input the call accept message such as, for example, voice recognition input interface, motion detection input interface, key pad input interface, etc. to receive the user input.

The transportation call service server 400, in response to receiving the call accept message from the vehicle terminal 200, may assign the vehicle (for example “vehicle B”) corresponding to the vehicle terminal 200 which transmitted the call accept message to the transportation call server 400 to the user A, and may generate a vehicle assignment message indicating that, for example, the vehicle B is assigned to the user A, and may transmit the vehicle assignment message to the user terminal 100 of user A (S70).

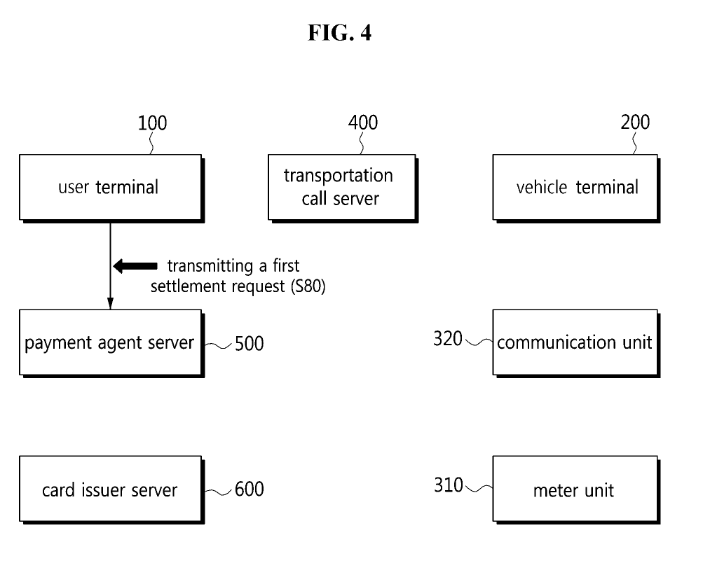

FIG. 4 is a diagram illustrating a first stage of payment process after processes of FIG. 3.

Referring to FIG. 2 and FIG. 4, the user terminal 100 may generate a first settlement request and may transmit the first settlement request to the payment agent server 500 (S80). The payment agent server 500 may then process the payment of the transportation fare in response to the first settlement request.

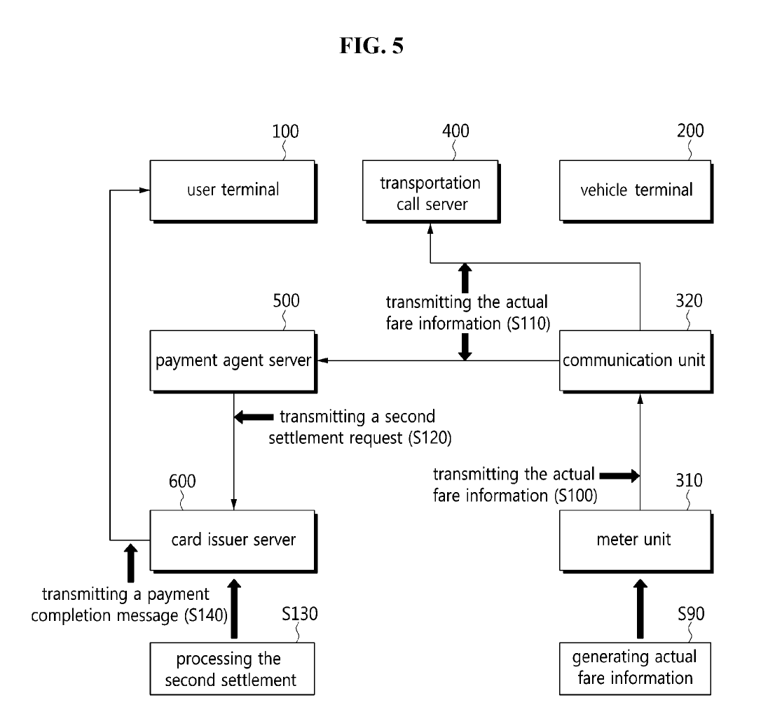

FIG. 5 is a diagram illustrating a second stage of payment process after processes of FIG. 4.

Referring to FIG. 2 and FIG. 5, a passenger (for example, passenger C) may board on the transportation vehicle B. In response to the passenger C boarding, the driver of the vehicle B may check whether the passenger C is the passenger assigned to the vehicle B using the passenger information included in the call request information. The vehicle terminal 200 may be configured to notify the driver of the passenger information in, for example, voice, screenshot, or text.

Then, the meter unit 310 may generate actual fare information based on, for example, travel distance and/or time until the transportation vehicle B arrives the destination (S90) and may transmit the actual fare information to the communication unit 320 (S100). The meter unit 310 may generates the actual fare information in response to a user input upon arrival at the destination or other inputs to finalize the fare. For example, the actual fare information may be generated when the driver pushes a button on the meter unit or touches a button displayed on the vehicle terminal 200 to finalize the fare.

The communication unit 320 may transmit the actual fare information to the payment agent server 500 or, alternatively, to the transportation call service server 400 (S110). The transportation call service server 400 may store the actual fare information received from the communication unit 320.

Then, the payment agent server 500 may generate a second settlement information using the first settlement information and the actual fare information, and may transmit the second settlement information to the card issuer server 600 (S120).

Subsequently, the card issuer server 600 may perform a second settlement process (approval of payment of the transportation fare) using the second settlement information received from the payment agent server 500 (S130), and may then generate payment completion message to be transmitted to the user terminal 100 (S140). In response to receiving the payment completion message by the user terminal 100, the user A may be informed of completion of the payment. The transmission of the payment completion signal may be performed through the transportation call service application or a text message service such as SMS, but exemplary embodiments are not limited thereto.

In an exemplary embodiment, the payment agent server 500 may transmit a payment agent fee to the card issuer server 600 when the payment agent fee occurs during the above payment process. At this time, the card issuer server 600 may process the payment agent fee when performing the second settlement, and separately process the settlement fee. Here, the payment agent fee may be for a one-time or multi-use service using the transportation service call service, and may be an optional fee applied according to the optional information provided in the transportation call request. In addition, the payment agent server 500 may award a certain portion of the payment amount back to the user A or provide a discount coupon as a reward according to the payment method as described above.

On the other hand, if the first settlement process has failed or fails, the second settlement process may not be performed. Accordingly, the passenger may need to perform an on-site payment when he or she gets off the transportation vehicle.

Hereinafter, a exemplary method of transportation call service according to an exemplary transportation fare payment scenario will be described in detail.

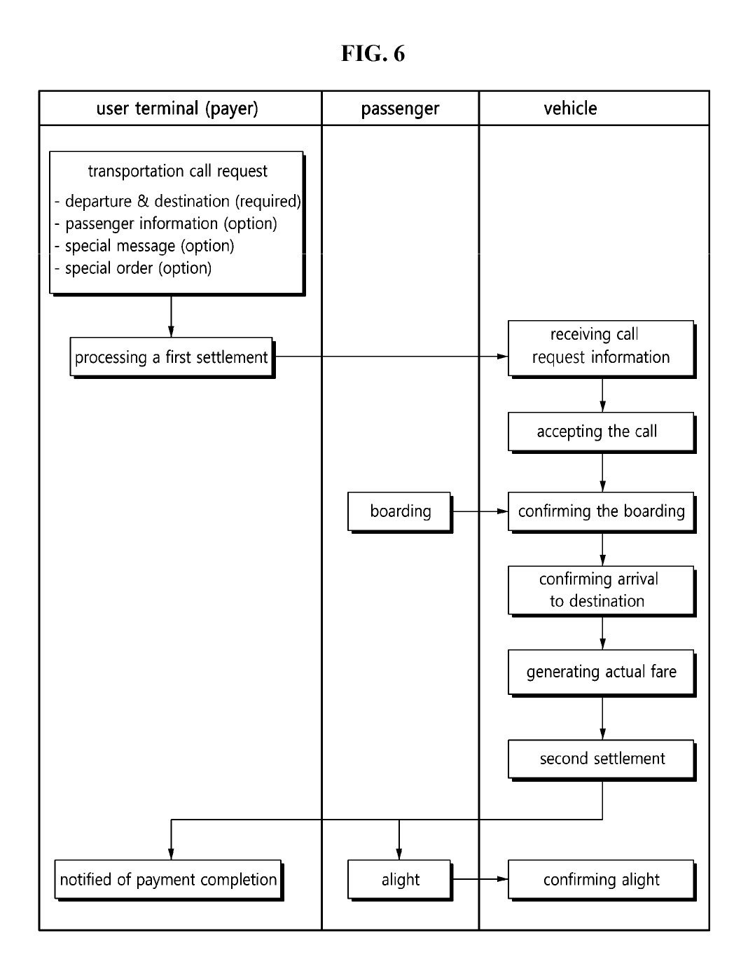

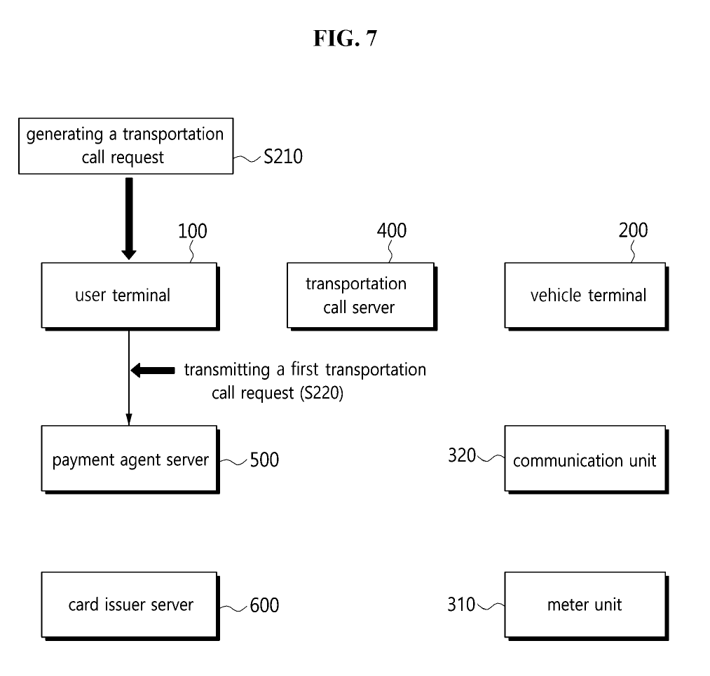

FIG. 6 is a flowchart illustrating an exemplary transportation fare payment scenario, and FIG. 7 is a block diagram illustrating a process of performing a first settlement process and second settlement process under the exemplary transportation fare payment scenarios illustrated in FIG. 2 and FIG. 6.

Referring to FIG. 6 and FIG. 7, a user A who is also a payer may input a transportation call request to call a vehicle for transportation after executing a transportation service call service application on the user terminal 100 of the user. For example, the user terminal 100 may generate the transportation call request by touch input of a user (S210).

Then, the user A may request for the first settlement using the user terminal 100. That is, the user terminal 100 may generate the first settlement information for the first settlement process and may transmit the first settlement request to the payment agent server 500 (S220). At this time, the payment agent server 500 may perform the first settlement process using the first settlement request.

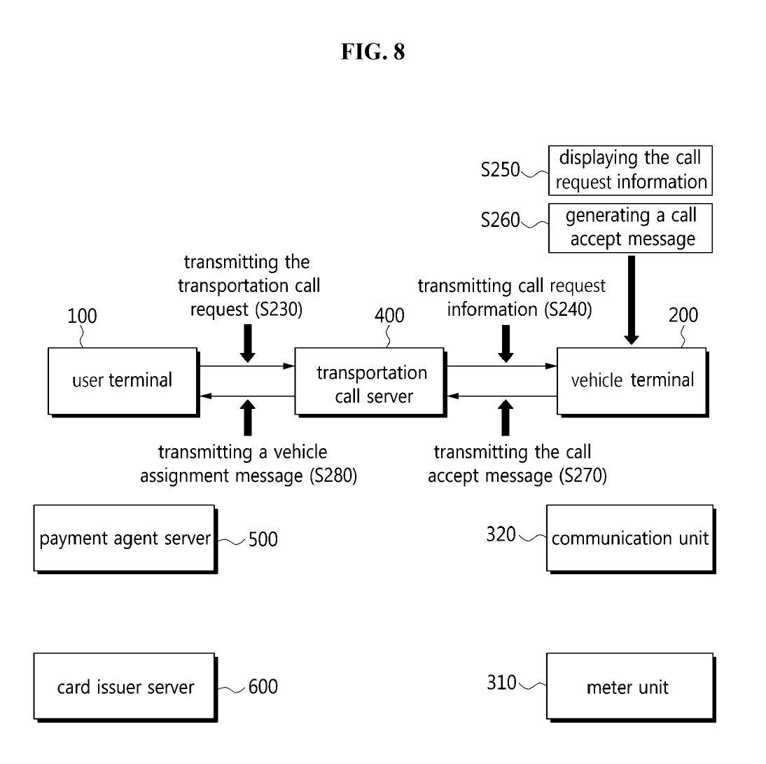

FIG. 8 illustrates an exemplary process of call and acceptance of the transportation call service, which is performed after the process of FIG. 7.

Referring to FIG. 6 and FIG. 7, after the transmission of the first settlement information is completed, the user terminal 100 transmits the transportation call request to the server 400 (S230).

Then, the transportation call server 400 may generate a call request information using the transportation call request transmitted from the user terminal 100, and then transmits the call request information to the vehicle terminal 200 (S240).

In response to receiving the call request information, the vehicle terminal 200 may display the call request information (S250).

Then, the vehicle terminal 200 may generate a call accept message (S260) and transmits the call accept message to the transportation call server 400 (S270). For example, a driver of a vehicle acting as an operator may input whether he or she accept the user's call through the vehicle terminal 200 after he or she is notified of the call request information. The vehicle driver may input the call accept message via a touch screen on the vehicle terminal 200. The vehicle terminal 200 may have other user input interfaces such as, for example, voice recognition input interface, motion detection input interface, key pad input interface, etc. to receive the user input, but exemplary embodiments are not limited thereto.

The transportation call server 400, in response to receiving the call accept message from the vehicle terminal 200, may assign the vehicle (for example “vehicle B”) corresponding to the vehicle terminal 200 which transmitted the accept message to the transportation call server 400 to the user A, and may generate a vehicle assignment message indicating that the vehicle B is assigned to the user A, and may transmit the vehicle assignment message to the user terminal 100 of user A.

Meanwhile, since the process is substantially the same as the process of performing the second settlement described above with reference to FIG. 5, a detailed description of each step thereof will be skipped. Since, according to the scenario illustrated in FIG. 6, the call and acceptance process with a driver of transportation vehicle is performed after the first settlement process, the following process may be automatically performed or may be blocked if a failure occurs in the first settlement process. Accordingly, the on-site settlement process of FIG. 2, which occurs when a failure or failure occurs in the first settlement process, may be omitted in the scenario of FIG. 6. In addition, since the fare input by the user is completed before the acceptance of the transportation call request, the convenience of the user can be further improved.

Hereinafter, exemplary embodiments of the first settlement and the second settlement process will be described.

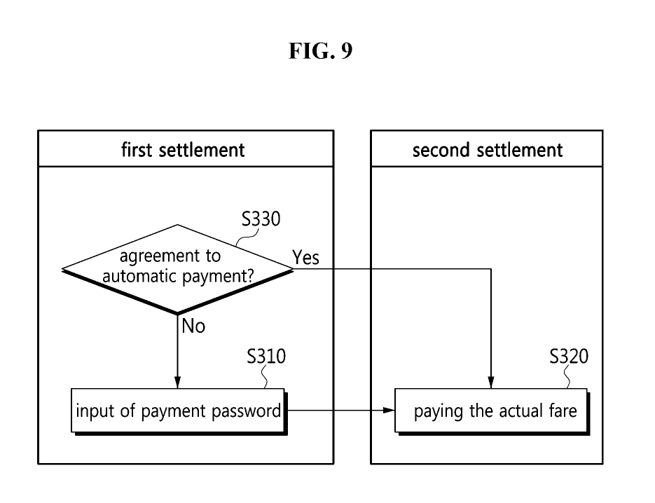

FIG. 9 is a flowchart illustrating an example of a process of first settlement and second settlement in the payment scenario of FIG. 2 or FIG. 6.

Referring to FIG. 9, the first settlement request transmitted from the user terminal 100 to the payment agent server 500 may include a payment password generated by the user terminal 100. That is, when the user A inputs the payment password through the user terminal 100 of user A, the user terminal 100 may transmit the payment password to the payment agent server 500 (S310). At this time, the payment agent server 500 may store the payment password only for a predetermined time period after which the actual payment can be performed, for example, 3 to 4 hours, but exemplary embodiments are not limited thereto. The first settlement request may further include information on a payment agent fee.

The second settlement request transmitted from the payment agent server 500 to the card issuer server 600 may include the actual fare information transmitted from the payment process device such as a meter unit 310. That is, the payment agent server 500 may forward the actual fare information to the card issuer server 600 to finalize the payment of the transportation fare (S320). Here, if the first settlement request includes information on the payment agent fee, the payment agent server 500 may transmit the payment agent fee together with the actual fare information to the card issuer server 600 to process the payment.

Meanwhile, the payment agent server 500 may store an automatic payment information for allowing the payment of the transportation fare to be processed automatically using the payment means registered by the user A, for example, the card registered by the user A. At this time, the automatic payment information may include the payment password of the user A input by the user terminal 100 for the first fare payment. That is, when the user A performs the initial fare payment, the payment process may be automatically performed without additional consent unless a cancellation action is done.

When the payment agent server 500 stores the automatic payment information, the first settlement request may include the identification information of the user A for performing the automatic payment process using the automatic payment information. That is, the user terminal 100 determines whether there is an automatic payment agreement of the user (S330). If it is determined that the automatic settlement agreement exists, the user terminal 100 automatically transmits the stored identification information about the user A to the payment agent server 500. Thereafter, in step S320, the payment agent server 500 may transmit the final transportation fare to the card issuer server 600 using the identification information of the user A for the payment of the final transportation fare to be approved.

On the other hand, if the user terminal 100 determines that there is no automatic payment agreement, the user terminal 100 may perform the step of S310 to process the payment.

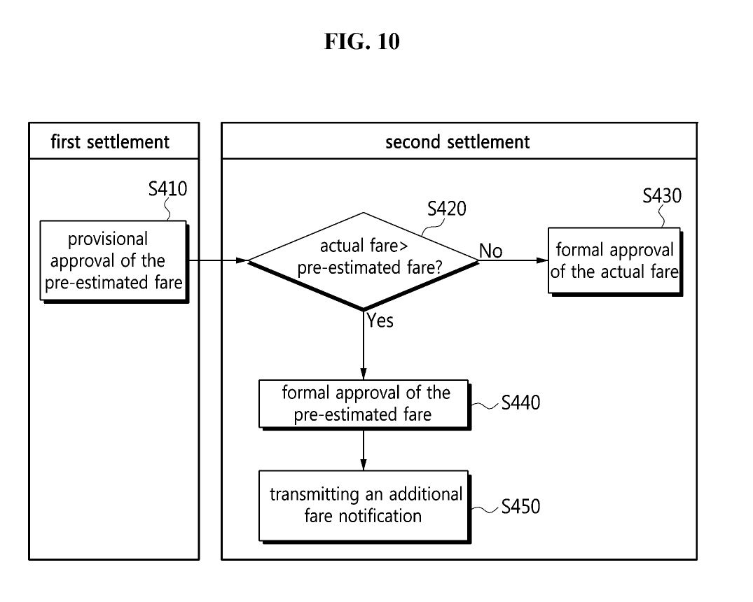

FIG. 10 is a flowchart for explaining an exemplary example of a process of first settlement and second settlement in the transportation fare payment scenario of FIG. 2 or FIG. 6.

Referring to FIG. 10, the first settlement request transmitted from the user terminal 100 to the payment agent server 500 may include a request for provisional approval of the pre-estimated fare. That is, after the user terminal 100 determines the pre-estimated fare, the user terminal 100 transmits a request for approval of the pre-estimated fare to the payment agent server 500 (S410). Here, the provisional payment information may include a payment password generated by an input from the user terminal 100.

In an exemplary embodiment, the pre-estimated fare may be determined by the area of the transportation. For example, when the area of the transportation is Seoul, the average cost may be determined by setting an average cost based on a moving distance and/or a moving time to cover the Seoul area. The pre-estimated fare may also be determined according to a calculated travel distance between the departure location and the destination. For example, when the user A inputs the departure location and the destination location, the travel distance may be calculated based on the departure location and the destination departure location and the pre-estimated fare may be determined using the calculated travel distance. However, exemplary embodiments are not limited thereto.

While the pre-estimated fare is generated by the user terminal 100 in the above description, the pre-estimated fare may be generated by the transportation call server 400. For example, the transportation call server, in response to receiving the departure and destination location from the user terminal 100, may calculate a route from the departure location to the destination location using the map DB and generate the pre-estimated fare based on the calculated route. The generated pre-estimated fare may be transmitted from the transportation call server 400 to the user terminal 100 for user reference.

The second settlement request transmitted from the payment agent server 500 to the card issuer server 600 may include a request for a formal approval of paying the pre-estimated fare if the actual fare is higher than the pre-estimated fare and paying the final transportation fare otherwise. If the payment agent server 500 determines that an additional fare is generated due to the actual fare being higher than the pre-estimated fare, the payment agent server 500 may transmit to the vehicle terminal 200 an additional fare notification that payment for the additional fare is required.

For example, the payment agent server 500 may compare the final transportation fare transmitted from the fare determination unit 300 with the pre-estimated fare (S420), if the final transportation fare is determined to be equal to or lower than the pre-estimated fare, the payment agent server 500 may transmit the final transportation fare to the card issuer server 600 for the payment of the final transportation fare to be processed (S430).

On the other hand, when the payment agent server 500 determines that the final transportation fare is higher than the pre-estimated fare and additional fare is generated, the payment agent server 500 may transmit a request for a formal approval of the pre-estimated fare to the card issuer server 600 (S440) for the pre-estimated fare to be paid as a final fare. And thereafter or at the same time, the payment agent server 500 may transmit the additional fare notification signal to the vehicle terminal 200 (S450). The additional fare notification signal may be directly transmitted from the payment agent server 500 to the vehicle terminal 200, or may be transmitted through the transportation call server 400 from the payment agent server 500 to vehicle terminal 200.

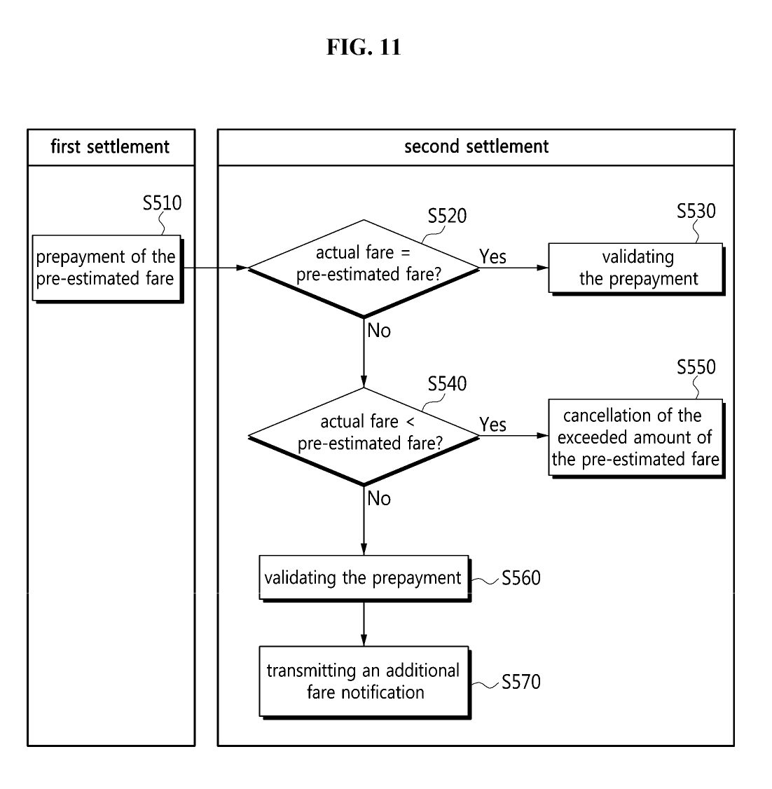

FIG. 11 is a flowchart for explaining an exemplary embodiment of the process of the first settlement and the second settlement in the payment scenario of FIG. 2 or FIG. 6.

Referring to FIG. 11, the first settlement request transmitted from the user terminal 100 to the payment agent server 500 may include a request for prepayment of the pre-estimated fare. That is, after the user terminal 100 determines the pre-estimated fare, the user terminal 100 may transmit a request for approval of prepayment of the pre-estimated fare to the payment agent server 500 (S510). Then, the payment agent server 500 may access the card issuer server 600 in response to the first settlement request to process the prepayment of the pre-estimated fare.

In an exemplary embodiment, the first settlement request may include a payment password generated by the user terminal 100 according to a user input. In addition, the pre-estimated fare may be determined by the area of the transportation and/or may be determined according to the travel distance between the departure location and the destination.

The second settlement request transmitted from the payment agent server 500 to the credit card issuer server 600 includes a request for validating the prepayment if the actual fare transmitted from the communication unit 320 of the payment device is equal to or greater than the pre-estimated fare. Also, the second settlement request transmitted from the payment agent server 500 to the credit card issuer server 600 may include a cancel request for canceling the prepayment when the actual fare is lower than the pre-estimated fare. The cancellation of the prepayment may be performed for an amount of the pre-estimated fare exceeding the actual fare. Alternatively, the prepayment may be entirely canceled and a new request for payment for the actual fare may be generated. If the payment agent server 500 determines that an additional fare is generated due to the actual fare being higher than the pre-estimated fare, the payment agent server 500 generates and transmits to the vehicle terminal 200 an additional fare notification indicating that further payment for the additional fare is required.

More specifically, the payment agent server 500 compares the actual fare, which is transmitted from the communication unit 320 of the payment device, with the pre-estimated fare (S520). If the actual fare is determined to be equal to or greater than the pre-estimated fare, the prepayment of the pre-estimated fare may be validated (S530). When a prepayment is a correct and valid payment and no further process if performed thereafter, prepayment is validated. If the payment agent server 500 determines that an additional fare is generated due to the actual fare being higher than the pre-estimated fare, the payment agent server 500 may be further configured to transmit to the vehicle terminal 200 an additional fare notification that payment for the additional fare is required.

On the other hand, the payment agent server 500 accesses the card issuer server 600 for the exceeded amount of the prepayment to be canceled from the provisional payment if the actual fare is determined to be lower than the pre-estimated fare (S540).

Meanwhile, when the payment agent server 500 determines that the final transportation fare is higher than the pre-estimated fare and the additional fare occurs, the payment agent server 500 may validate the pre-estimated fare (S560). And thereafter or at the same time, the payment agent server 500 may transmit the additional fare notification signal to the vehicle terminal 200 (S570). At this time, the additional fare notification signal may be directly transmitted from the payment agent server 500 to the vehicle terminal 200, or may be transmitted through the transportation call server 400 from the payment agent server 500 to transportation terminal 200.

As described above, according to an exemplary embodiment, since the user A (the payer) performs the online payment through the user terminal 100 before the passenger boards the vehicle, even if the user A (the payer) is not identical to an actual passenger, payment of transportation fare can be performed. For example, a passenger who does not have a payment means, e.g., a child, an elderly person, a disabled person, or the like, may use a vehicle more conveniently because a parent or a guardian may be a payer and perform settlement on-line in advance using the exemplary transportation call and acceptance system and method.

In addition, when the call and acceptance process is performed after the first settlement process is completed, the on-site settlement process that occurs when the first settlement process fails may be omitted. Therefore the convenience of the user can be further improved.

When the surcharge occurs, the additional fare notification signal is transmitted to the vehicle terminal 200, so that a driver of the vehicle may be notified of the surcharge via the vehicle terminal 200 so that it is possible to facilitate the on-site settlement of the additional cost to the actual boarding passenger.

Although certain exemplary embodiments and implementations have been described herein, other embodiments and modifications will be apparent from this description. Accordingly, the inventive concept is not limited to such exemplary embodiments, but rather to the broader scope of the presented claims and various obvious modifications and equivalent arrangements.

What is claimed is:

1. A transportation call service system comprising:
a first terminal configured to generate a transportation call request and a first settlement request for a first settlement of a payment of a transportation fare;
a transportation call server configured, in response to receiving the transportation call request from the first terminal, to generate a vehicle assignment message indicating the a vehicle that has been assigned and to transmit the vehicle assignment message to the first terminal; and
a payment agent server configured to process the payment of the transportation fare using an actual fare information and the first settlement request, wherein the actual fare information is generated according to a service operation of the assigned vehicle.

2. The system of claim 1 further comprising a second terminal configured to receive a call request information from the transportation call server, to generate an acceptance message indicating that the transportation call request is accepted, and to transmit the acceptance message to the transportation call server,
wherein the call request information is generated by transportation call server based on the transportation call request.

3. The system of claim 2,
wherein the transportation call server transmits the vehicle assignment message to the first terminal in response to receiving the acceptance message from the second terminal.

4. The system according to claim 1,
wherein the first terminal is further configured to transmit the transportation call request to the transportation call server and the first settlement request to the payment agent server.

5. The system according to claim 2,
wherein the payment agent server is further configured to generate a second settlement request including the actual fare information and to transmit the second settlement request to a card issuer server for settlement of the payment of the transportation fare.

6. The system of claim 5,
wherein the first settlement request comprises a payment password generated by the first terminal, and
the second settlement request comprises the actual fare information.

7. The system of claim 6,
wherein the payment agent server is further configured to store the payment password for a predetermined period of time.

8. The system of claim 5,
wherein the payment agent server is further configured to store an automatic payment information to allow the payment of the transportation fare to be automatically processed in an automatic payment process,
wherein the first settlement request further comprises a user identification information, the payment agent server comparing the user identification information with the stored automatic payment information to perform the automatic payment process in response to receiving the first settlement request, and
wherein the second settlement request comprises the actual fare information.

9. The system of claim 8,
wherein the automatic payment information comprises a payment password generated by the first terminal.

10. The system according to claim 5,
wherein the first settlement request comprises a request for provisional approval of a pre-estimated fare, and
the second settlement request comprises a request for a formal approval of the transportation fare, wherein the transportation fare is an actual fare if the actual fare is equal to or lower than the pre-estimated fare and the pre-estimated fare if the actual fare is higher than the pre-estimated fare.

11. The system of claim 10,
wherein the payment agent server is further configured to generate an additional fare notification indicating that the actual fare is determined to be higher than the pre-estimated fare and payment for a difference between the actual fare and the pre-estimated fare needs to be processed, and to transmit the additional fare notification to the second terminal when the actual fare is determined to be higher than the pre-estimated fare.

12. The system of claim 10,
wherein the request for provisional approval comprises a payment password generated by the first terminal.

13. The system of claim 5,
wherein the first settlement request comprises a request for prepayment of a pre-estimated fare, and
the second settlement request comprises a request for validating the prepayment when an actual fare is equal to or higher than the pre-estimated fare and a request for canceling an exceeding amount of the pre-estimated fare when the actual fare is lower than the pre-estimated fare.

14. The system of claim 13,
wherein the payment agent server is further configured to generate an additional fare notification indicating that the actual fare is higher than the pre-estimated fare and payment for a difference between the actual fare and the pre-estimated fare needs to be processed, and to transmit the additional fare notification to the second terminal when the actual fare is determined to be higher than the pre-estimated fare.

15. The system of claim 10,
wherein the pre-estimated fare is determined according to an area of the transportation.

16. The system of claim 10,
wherein the pre-estimated fare is determined based on a travel distance between a departure location and a destination location.

17. The system of claim 1,
wherein the transportation call request comprises information about a departure location and a destination location.

18. The system of claim 17,
wherein the transportation call request further comprises a passenger information.

19. The system of claim 17,
wherein the transportation call request further comprises message information to be sent to a driver of the vehicle.

20. The system of claim 17,
wherein the transportation call request further comprises an optional information indicating.

21. The system of claim 5,
wherein the card issuer server is configured to transmit a settlement completion message indicating completion of the payment of the transportation fare to the first terminal.

22. The system of claim 5,
wherein the payment agent server is further configured to transmit a payment agent fee information to the card issuer server for settlement of a payment agent fee.

23. The system of claim 1, further comprising a fare determination module generating an actual fare and transmitting the actual fare to the payment agent server.

24. The system of claim 23, wherein the fare determination module comprises:
a meter unit generating the actual fare; and
a communication unit receiving the actual fare from the meter unit and transmitting the actual fare to the payment agent server.

25. A method of transportation call service performed by a first terminal in wireless communication with a transportation call server and a payment agent server, the method comprising:
transmitting a transportation call request to the transportation call server;
receiving a vehicle assignment message from the transportation call server, wherein the vehicle assignment message indicating a vehicle has been assigned is generated by and transmitted from the transportation call server in response to the transportation call request; and
transmitting a first settlement request to the payment agent server, wherein the payment agent server processes a payment of a transportation fare using an actual fare information and the first settlement request, wherein the actual fare information is generated according to a service operation of the assigned vehicle.

26. The method of claim 25,
wherein transmitting the call request to the transportation call server is performed after transmitting the first settlement request to the payment agent server.

27. The method of claim 26,
wherein the first settlement request comprises a payment password generated by the first terminal.

28. The method of claim 26,
wherein the payment agent server stores an automatic payment information to allow the payment of transportation fare to be automatically processed in an automatic payment process, and
wherein the first settlement request further comprises a user identification information, the payment agent server comparing the user identification information with the stored automatic payment information to perform the automatic payment process in response to receiving the first settlement request.

29. The method of claim 28,
wherein the first settlement request comprises a request for provisional approval of a pre-estimated fare.

30. The method of claim 26,
wherein the first settlement request comprises a request for prepayment of a pre-estimated fare.

31. The method of claim 29, further comprising determining the pre-estimated fare.

32. The method of claim 30, further comprising determining the pre-estimated fare.

33. The method of claim 31,
wherein the pre-estimated fare is determined according to an area of the transportation.

34. The method of claim 31,
wherein the pre-estimated fare is determined based on a travel distance between a departure location and a destination location.

35. The method of claim 32,
wherein the pre-estimated fare is determined according to an area of the transportation.

36. The method of claim 32,
wherein the pre-estimated fare is determined based on a travel distance between a departure location and a destination location.

37. The method of claim 27, further comprising receiving a payment completion message indicating completion of payment of the transportation fare from a card issuer server.

38. The method of claim 25,
wherein the transportation call request comprises information about a departure location and a destination location.

39. A method of a transportation call service performed by a payment agent server in wireless communication with a first terminal and a second terminal, comprising:
receiving a first settlement request for a first payment process from the first terminal;
receiving a pre-estimated fare information generated according to a transportation of an assigned vehicle; and
processing payment of a transportation fare using an actual fare and the first settlement request.

40. The method of claim 39,
wherein the receiving a first settlement request is performed before the first terminal transmits a transportation call request to a transportation call server.

41. The method of claim 40, further comprising transmitting a second settlement request to a card issuer server for the payment to be approved.

42. The method of claim 41,
wherein the first settlement request comprises a payment password generated by the first terminal, and
the second settlement request comprises information of the actual fare.

43. The method of claim 41, further comprising storing an automatic payment information to allow the payment of transportation fare to be automatically processed in an automatic payment process,
wherein the first settlement request further comprises an identification which the payment agent server compares with the stored automatic payment information to perform the automatic payment process in response to receiving the first settlement request, and
the second settlement request comprises information of the actual fare.

44. The method of claim 41,
wherein the first settlement request comprises a request for provisional approval of a pre-estimated fare, and
the second settlement request comprises a request for a formal approval of the transportation fare, wherein the transportation fare is the actual fare if the actual fare is equal to or lower than the pre-estimated fare and the pre-estimated fare if the actual fare is higher than the pre-estimated fare.

45. The method of claim 44, further comprising:
generating an additional fare notification indicating that the actual fare is higher than the pre-estimated fare and payment for a difference between the actual fare and the pre-estimated fare needs to be processed; and
transmitting the additional fare notification to the second terminal when the actual fare is determined to be higher than the pre-estimated fare.

46. The method of claim 41,
wherein the first settlement request comprises a request for prepayment of a pre-estimated fare, and
the second settlement request comprises a request for validating the prepayment when the actual fare is equal to or higher than the pre-estimated fare and a request for canceling an exceeding amount of the pre-estimated fare when the actual fare is lower than the pre-estimated fare.

47. The method of claim 46, further comprising:
generating an additional fare notification indicating that the actual fare is higher than the pre-estimated fare and payment for a difference between the actual fare and the pre-estimated fare needs to be processed; and
transmitting the additional fare notification to the second terminal when the actual fare is determined to be higher than the pre-estimated fare.

48. The method of claim 44,
wherein the pre-estimated fare is determined according to an area of the transportation.

49. The method of claim 44,
wherein the transportation call request comprises information about a departure location and a destination location.

50. The method of claim 46,
wherein the pre-estimated fare is determined according to an area of the transportation.

51. The method of claim 46,
wherein the transportation call request comprises information about a departure location and a destination location.

52. The method of claim 41, further comprising transmitting a payment agent fee information to the card issuer server for payment of a payment agent fee.

53. The system of claim 13,
wherein the pre-estimated fare is determined according to an area of the transportation.

54. The system of claim 13,
wherein the pre-estimated fare is determined based on a travel distance between a departure location and a destination location.
